(19) United States
(12) Patent Application Publication
(10) Pub. No.: US 2014/0039922 A1
(43) Pub. Date: Feb. 6, 2014

(54) METHOD OF OBTAINING DISCRETE OUTCOME DATA

(71) Applicant: Uri Lopatin, San Francisco, CA (US)

(72) Inventor: Uri Lopatin, San Francisco, CA (US)

(21) Appl. No.: 13/565,939

(22) Filed: Aug. 3, 2012

(51) Int. Cl. G06Q 30/02; G06Q 50/22

(52) U.S. Cl. CPC G06Q 30/0203; G06Q 50/22
USPC 705/3; 705/2

(57) ABSTRACT

A method for correlating health care interventions with a medical condition of a patient which includes ascertaining a medical condition of a patient, running diagnostic tests on the patient, diagnosing the patient based on medical data, assigning a health care intervention for the patient, displaying of information on a user interface, wherein the information includes the patient information, the health care intervention, and a plurality of outcomes, and in response to an action being performed, documenting an outcome corresponding to the health care intervention for a patient.

### BACKGROUND OF THE INVENTION

### Field of the Invention

Instances arise where there is a need to properly document and correlate a particular result, or a discrete outcome to a specific event or a specific intervention. As a specific example, in the health care industry, there is a need to correlate outcomes to a specific intervention prescribed by a health care provider. However, currently there is no direct link nor correlation within electronic health records between a patient's diagnosis, a patient's treatment, and a patient's outcome.

Instead, the conventional method of documenting patient care may document discrete disease events (such as myocardial infarction, or elevated blood pressure), hospital discharge, and interventions (angioplasty, anti-hypertensive medication, and hospital admissions) without a direct link to a patient's outcome (e.g., patient was prescribed an anti-hypertensive, and as a result the blood pressure is now normal).

That is, the current process in the health care industry of determining the effectiveness of a patient's intervention is by proxy: by tracking events (such as patient discharges and re-admittances) against interventions without discrete assignment of causality. As a result, there is limited accurate searchable measure of actual effectiveness of interventions. Additionally, when such data is available, it is often time delayed, after searching through correlations, rather than being available in real time.

For example, a patient may seek treatment at a health care facility when he/she is not feeling well. A physician or healthcare provider may then diagnose the patient according to his/her symptoms and create a first diagnosis for the patient based on his/her symptoms and test results. The physician may then prescribe a particular intervention (i.e., a first intervention) for the patient according to the first diagnosis. Often times, after the particular diagnostic procedure or intervention, neither the physician nor patient reports whether the diagnostic was procedure provided a definitive diagnosis nor what affect the intervention had upon the symptoms. Thus, in this instance, a palpable disconnect exists, whereby the lack of direct correlation between a particular outcome and discrete outcome negatively impacts the ability of the health care field to ascertain the effectiveness of an intervention.

It is therefore useful to provide a simple method of correlating a discrete outcome to a particular intervention, via a single action, click, and/or swipe being performed, to document the result of a health care intervention, which serves to provide accurate intervention efficacy information, and further, facilitates evaluation of medical care by providing a discrete searchable field for subsequent data analysis

It is also useful to implement a method whereby the health of a patient, and their response to an intervention is made of paramount importance, while simultaneously increasing the accountability and efficiency of the health care environment.

### SUMMARY OF THE INVENTION

The present general inventive concept relates to a method of correlating a discrete outcome to a particular intervention, and more particularly, as applied to a healthcare environment, a method of correlating a medicinal, behavioral, or procedural intervention to its outcome on a patient.

The present general inventive concept further relates to a method of correlating a discrete outcome to a particular intervention, via the actuation of a one-click or one-touch button by a user.

Additional aspects and utilities of the present general inventive concept will be set forth in part in the description which follows and, in part, will be obvious from the description, or may be learned by practice of the general inventive concept.

The discrete outcome following an intervention may include, for example, an indication that the patient's condition is the “better,” “same, ” “worse,” “resolved,” “useful,” or “not useful,” thereby providing valuable feed back for the healthcare provider about the success or lack thereof an intervention.

The method of the present general intervention concept runs on a loop, and may be repeated as many times is necessary, or a distinct goal is achieved (for example indicating that the patient is no longer in need of medical care).

The present general inventive concept may be applied to such medical treatments, such as, but not limited to: medication, physical therapy, occupational therapy, dietary changes, activity level changes, surgical procedures, vitamin intake, and lifestyle changes. It is essential to the health of a patient that both the healthcare provider and the patient are aware of discrete outcomes of individual and specific outcomes. The undertaking of a single action, or the actuation of a single device simplifies this process, which when repeated over the course of time, generates an extensive database of intervention effectiveness information which may be aggregated.

The compiled aggregated data can thereafter be mined via algorithms, such that broad patterns and consistencies are recognized and, in turn, may be used to increase the efficiency of a healthcare diagnosis and intervention. For example, when another patient presents similar complaints and has similar symptoms, a healthcare provider with access to the tools described within need not run the same battery of tests; instead, reference is made to the complied aggregated data to revise the testing and treatment protocols, reducing wasted time and resources.

The general inventive concept may also include a patient-operated feedback system, whereby the patient may access and review the assessments of the health care provider, so as to confirm, modify, or comment upon whether the discrete outcome correlates to the specific intervention, as indicated by the healthcare provider.

The present general inventive concept provides a method and system for correlating a discrete outcome to a particular intervention. In particular, an embodiment according to the present general inventive concept can be configured for a healthcare environment, wherein the interventions include medicinal interventions and procedural interventions, and the discrete outcomes indicate whether the intervention improved, worsened, or had no effect on the patient's condition. For instance, the discrete outcomes may include the “better,” “same, “worse,” “resolved,” “useful,” or “not-useful.”

A healthcare provider or other user creates a patient profile that is entered within a system database. The patient profile includes the patient's medical history record data, which may be manually entered by an individual such as a health care provider or may be automatically populated by a secondary database.

In an exemplary embodiment, a patient may go to a health care facility when he/she is not feeling well. A physician or healthcare provider may then diagnose the patient according to his/her symptoms and create a first diagnosis for the patient based on his/her symptoms and test results. The physician may then prescribe a particular intervention (i.e., a first intervention) for the patient according to the first diagnosis. The first diagnosis and first intervention may then be entered into the patient's medical history record data within the patient's profile.

An exemplary embodiment of the method according to the present general inventive concept includes a user interface that displays the patient's diagnosis and prescribed interventions. In addition, the user interface displays a one-click button (or slider, or similar interface) in which the physician, patient, or other caretaker must complete for each intervention. The one-click button would indicate whether the intervention improved, worsened, or had no effect on the patient's condition.

For instance, after the health care provider or patient initiates the prescribed intervention, the health care provider may then select the one-click button indicating that the intervention improved the patient's condition. This data would then be updated within the patient's profile. The one-click button may include a button graphic which, when clicked would indicate “the same”, “better”, “resolved”, “worse,” “useful,” or “not useful.” In alternative exemplary embodiments, the one-click button may include a slide button which would indicate “the same” in a first position, “better” in a second position, “resolved” in a third position, “worse” in a fourth position, “useful” in a fifth position, or “not useful” in a sixth position.

Features and/or utilities of the present general inventive concept may be achieved by providing a method for correlating health care interventions with a medical condition of a patient, the method includes ascertaining the medical condition of a patient, running diagnostic tests on the patient, diagnosing the patient based on medical data, assigning a health care intervention for the patient, displaying of information on a user interface, wherein the information includes the patient information, the health care intervention, and a plurality of outcomes, in response to an action being performed, documenting an outcome corresponding to the health care intervention.

The plurality of outcomes may include better, worse, same, resolved, useful, and not-useful conditions.

Plurality of outcomes may be displayed in a format of clickable buttons.

Wherein the action may include clicking a button and/or an additional confirmation step. The confirmation step may be to confirm the selected outcome.

The method may further include creating a patient profile and designating a unique identifier corresponding to each patient profile.

The patient profile may include a patient's bibliographic information, a history of the patient's medical records, a patient's current medical conditions, a patient's′ current treatment data, a patient's current medication and/or medication regimens, and a visual display of a plurality of outcomes to document the result of a health care intervention.

Features and/or utilities of the present general inventive concept may also be achieved by providing a method for obtaining discrete outcome data corresponding to a patient's intervention which includes displaying a single user-friendly button on a user interface to indicate a plurality of outcomes of a user's intervention, determining the patient's outcome from the plurality of outcomes, and selecting the single user-friendly button corresponding to the determined patient outcome.

The user interface may include a personal computer, a mobile device, a tablet, and a dedicated electronic device.

The plurality of outcomes may include a first outcome corresponding to the patient's improved condition, a second outcome corresponding to the patient's worsened condition, a third outcome corresponding to the patient's condition remaining the same, a fourth outcome corresponding to the patient's condition being resolved, a fifth outcome corresponding to either the diagnosis or the health care intervention being useful, and a sixth outcome corresponding to either the diagnosis or the health care intervention not being useful.

The single user friendly button may include a slide button movable to a plurality of slide positions corresponding to each outcome, a button corresponding to each outcome, a wheel movable to a plurality of wheel positions corresponding to each outcome, and a selectable position on continuum scale.

The plurality of slide positions include a first slide position corresponding to the first outcome, a second slide position corresponding to the second outcome, a third slide position corresponding to the third outcome, a fourth slide position corresponding to the fourth outcome, a fifth slide position corresponding to the fifth outcome, and a sixth slide position corresponding to the sixth outcome. However, the present general inventive concept is not limited thereto. That is, the amount of positions and the types of interfaces to select between a discrete outcome or within a scale of continuous outcomes is not limited.

The plurality of wheel positions may include a first wheel position corresponding to the first outcome, a second wheel position corresponding to the second outcome, a third wheel position corresponding to the third outcome, a fourth wheel position corresponding to the fourth outcome, a fifth wheel position corresponding to the fifth outcome, and a sixth wheel position corresponding to the sixth outcome.

Features and/or utilities of the present general inventive concept may also be achieved by providing a method of correlating an outcome to a patient's intervention which includes receiving a unique identifier corresponding to each patient, receiving a diagnosis for each patient, receiving a health care intervention for each diagnosis, receiving a signal of a plurality of signals defining an outcome, and correlating the defined outcome to the unique identifier and at least one of the received diagnosis and the received health care intervention.

The diagnosis may be made according to a medical condition of the patient.

The health care intervention may be determined according to the diagnosis of the patient.

The plurality of signals may include a first signal representing a “better” condition, a second signal representing a “worse” condition, a third signal representing a “same” condition, a fourth signal representing a “resolved” condition, a fifth signal representing a “useful” condition, and a sixth signal representing a “not useful” condition.

The defined outcomes may correspond to the received diagnosis.

The defined outcomes may correspond to the received health care intervention.

The signal may be received when a user performs a single action.

The single action may include selecting a button corresponding to an actual outcome.

The wherein the single action further includes selecting a confirmation button to confirm the actual outcome.

The single action may include at least one of swiping a swipe button, rotating a digital wheel, selecting a point along a continuous scale, and selecting an image among a plurality of images.

The plurality of images may include a first image representing a “better” condition, a second image representing a “worse” condition, a third image representing a “same” condition, a fourth image representing a “resolved” condition, a fifth image representing a “useful” condition, and a sixth image representing a “not useful” condition. In exemplary embodiments, the first image may be a smiley face, the second image may be a frown face, the third image may be a face with a horizontal line for a mouth, and the fourth image may be a smiley face with a heart image.

The method may further include determining an amount of time between the receiving of the unique identifier of the patient and the receiving of the diagnosis of the patient.

The method may further include determining an amount of time between the receiving of the diagnosis of the patient and the receiving of the health care intervention of the patient.

The method may further include determining an amount of time between the receiving of the diagnosis of the patient and the receiving of the signal defining the outcome.

The method may further include determining an amount of time between the receiving of the health care intervention of the patient and the receiving of the signal defining the outcome.

The method may further include outputting efficiency data representing at least one of an efficiency of the diagnosis and an efficiency of the health care intervention based on at least one of the determined amounts of time.

Additional aspects of the present general inventive concept will be set forth in part in the description which follows and, in part, will be obvious from the description, or may be learned by practice of the general inventive concept.

### BRIEF DESCRIPTIONS OF THE DRAWINGS

These and/or other aspects of the present general inventive concept will become apparent and more readily appreciated from the following description of the embodiments, taken in conjunction with the accompanying drawings of which:

FIG. 1 is a flow diagram illustrating an exemplary embodiment of the method according to the present general inventive concept; and

FIG. 2 is a schematic illustrating of an exemplary embodiment of a system and device capable of implementing the method illustrated in FIG. 1.

### DETAILED DESCRIPTION

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

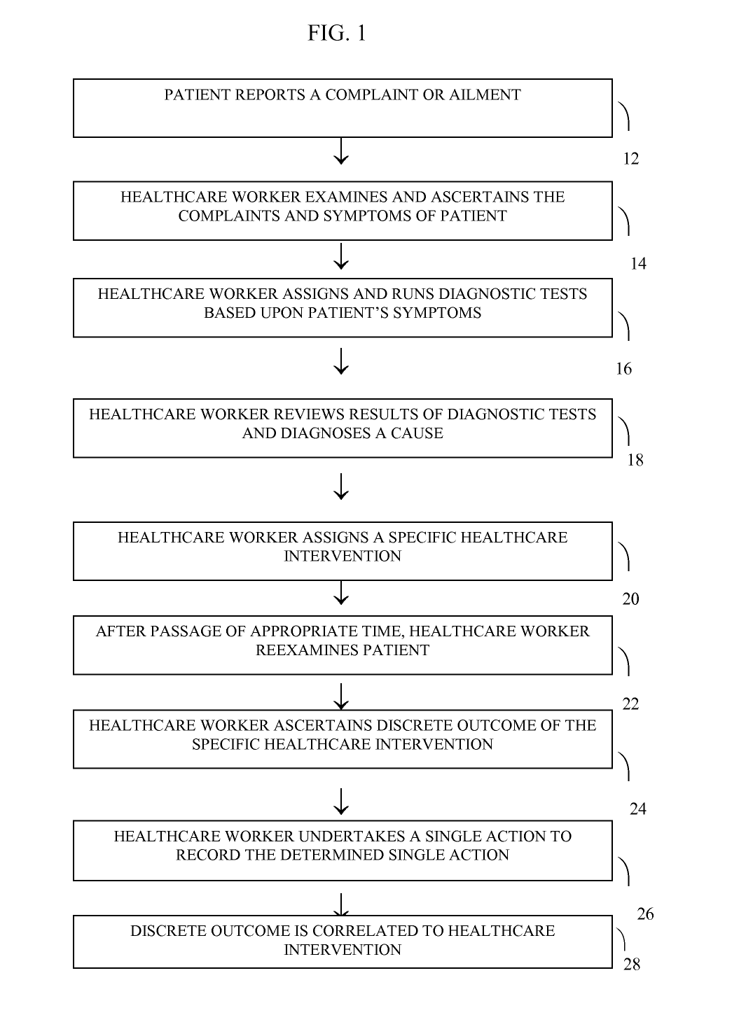

FIG. 1 is a flow diagram illustrating an exemplary embodiment of the method according to the present general inventive concept. A method, generally designated by the numeral 10, is performed as follows: at a step 12, a patient presents at a healthcare facility with a complaint, ailment, and or symptoms seeking treatment of said complaint, ailment, or symptoms.

At a step 14, a health care provider will examine and ascertain the source of the patient's complaint, ailment, and/or symptoms.

At a step 16, the health care provider will assign tests, diagnostic or otherwise, to be run on the patient, based upon the patient's complaints as well as the results of the initial examination.

At a step 18, the health care provider may obtain, and in turn, review the results of the tests; thereafter, the health care provider will diagnose a cause(s) of the patient's complaint, ailment, and/or symptoms. In an exemplary embodiment, the health care provider may perform a single click or swipe of a button to indicate whether the diagnostic tests were helpful or not helpful in diagnosing the cause of the patient's complaint, ailment, and/or symptoms. In addition, in an alternative embodiment, the health care provider may also perform a “click” or swipe of a button to assign a value to a diagnostic in order to provide data so that the diagnostic may be evaluated.

At a step 20, the health care provider assigns a specific initial intervention which is intended to improve the patient's health.

At a step 22, following the passage of time, in exemplary embodiments, the health care provider or the patient may perform a single click or swipe of a button to indicate whether their condition has improved.

At a step 24, the health care provider will ascertain the discrete outcome of the specific initial intervention, selecting the outcome from a pre-determined list of potential outcomes. For instance, the discrete outcomes may include the “better,” “same, “worse,” or “resolved or, the discrete outcomes could be represented as a rated scale from 0-10, or in some other similar manner.

At a step 26, the health care provider will undertake a single action, such as, but not limited to, clicking a button, swiping a finger, turning a knob, to indicate the discrete outcome of the specific initial intervention.

At a step 28, the discrete outcome is thereby correlated to the health care intervention.

At this point, if the initial intervention has been unsuccessful, either in total or in degree, the health care provider will proceed back to the appropriate steps (steps 12-20) in the process, and the method will be repeated again.

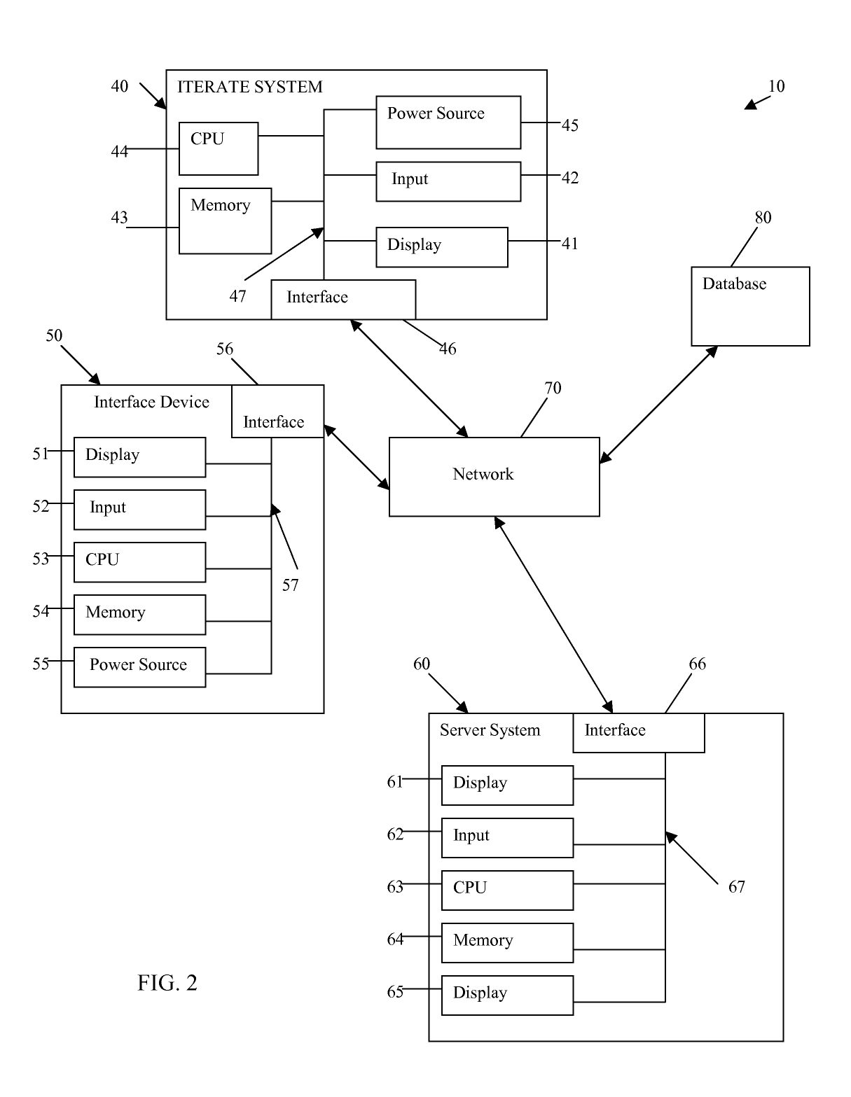

FIG. 2 is a schematic illustration of an exemplary embodiment of a system and device capable of implementing the method according to the present invention. The method of obtaining discrete outcome data of the present general inventive concept, hereinafter referred to as “system,” generally designated by the numeral 10, includes an iterative system 40, an interface device 50, a server system 60, a network 70 and a database 80.

System 10 is capable of properly documenting and correlating a discrete or continuous outcome to a specific event or intervention, such as correlating a patient's health outcome to a specific intervention prescribed by a health care provider. For instance, if the patient was experiencing pain, the continuous outcome would indicate whether the patient is experiencing less pain or more pain as a result of the specific intervention. In an exemplary embodiment, the continuous outcome may be represented on a scale from 0 to 10, where 0 corresponds to no pain and 10 corresponding to substantially greater pain. Furthermore, system 10 provide a simple method of correlating an outcome to a particular intervention, via a single action, click, and/or swipe being performed, to document the result of a health care intervention, which serves to provide accurate intervention efficacy information.

Iterate system 40 comprises a display 41, an input device 42, a memory 43, a CPU 44 and a system interface 46, a power source 45 and a bus subsystem 47 which links all of these components together making them available for communication with the entirety of system 10. CPU 44 is programmed to execute various programs of stored instructions including, but not limited to, accepting an entry of a single action from a device, such as, but not limited to, interface device 50, and recording an entry or discrete outcome, transferring the information to memory 43. Memory 43 not only stores the entry or discrete outcome, but also stores the programmed instructions to be executed by CPU 44, although it is understood the instructions could be stored in other components of system 10. Memory 43 may also store a data set, such as a individual patient's profile and medical history. Iterate system, via bus subsystem 47 and network 70, remains connected to the entirety of system 10.

Input 42 device enables system 10 to function without a specific interface device 50. For example, if a patient does not have access to an electronic device, they can call in from a telephone and either input their health status following the entry of a code-specific profile number, or provide the information to a data entry clerk who will enter the information. Alternatively, measures such as SMS may be used. Therefore, even individuals without the latest technology can ensure that there is a direct link or correlation between a patient's diagnosis, a patient's treatment, and a patient's outcome, instead of merely relying on discharge or re-admittance records.

Interface device 50 comprises a display 51, an input device 52, a memory 53, a CPU 54 and a system interface 56, a power source 55 and a bus subsystem 57 which links all of these components together making them available for communication with the entirety of system 10. CPU 54 is programmed to execute various stored programs, such as, but not limited to, obtaining a patient's medical history and profile from iterate system 40 or database 80, displaying a screen with a set of clickable and/or swipeable tabs or buttons, and transmitting the resultant single action of a user to iterate system 40 and database 80. Memory 53 not only stores the entry or discrete outcome, but also stores the programmed instructions to be executed by CPU 54, although it is understood the instructions could be stored in other components of system 10. Memory 53 may also store a data set, such as the user's profile and login information, so that the device 50 is secured.

Interface device 50 may be a cell phone, pda, tablet, PC, laptop or some other electronic device. Preferably, interface device 50 is interactive, and enables a health care provider, such as a doctor or nurse, or the patient himself/herself, via a single action, click, and/or swipe being performed on display 51 for example, an indication that the patient's condition is the “same,” “better,” “worse,” or “resolved” to document the discrete outcome of a health care intervention.

For example, a doctor on rounds may visit each patient to which he or she is assigned while carrying around an interface device 50, such as a tablet. As the doctor enters the room, he/she is able to pull up the profile and medical history of the patient, including the most recent intervention onto display 51. Following an examination, and possibly a conversation with the patient, following a single action, such as a tap, click or swipe on display 51, the discrete outcome of the unique intervention may be thereby been recorded and correlated, as the information is recorded not only within the memory 53 of device 50, but transferred to other integral components of system 10 such as iterate system 40 and database 80 over network 70.

Server system 60 comprises a display 61, an input device 62, a memory 63, a CPU 64 and a system interface 66, a power source 65 and a bus subsystem 67 which links all of these components together making them available for communication with the entirety of system 10. CPU 64 is programmed to execute various stored programs, such as, but not limited to, obtaining data sets of correlations from numerous devices 50 and database 80, and running a series of algorithms to detect overall patterns that may be mined to increase the efficiency of medical diagnosis and interventions in general. This would result in saving time, health, and money. Memory 63 stores the programmed instructions to be executed by CPU 54, although it is understood the instructions could be stored in other components of system 10. Memory 53 may also store data sets as needed.

In exemplary embodiments, the present general inventive concept may also be achieved by providing a method of correlating an outcome to a patient's intervention which includes receiving a unique identifier corresponding to each patient, receiving a diagnosis for each patient, receiving a health care intervention for each diagnosis, receiving a signal of a plurality of signals defining an outcome, and correlating the defined outcome to the unique identifier and at least one of the received diagnosis and the received health care intervention.

The diagnosis may be made according to a medical condition of the patient.

The health care intervention may be determined according to the diagnosis of the patient.

The plurality of signals may include a first signal representing a “better” condition, a second signal representing a “worse” condition, a third signal representing a “same” condition, a fourth signal representing a “resolved” condition, a fifth signal representing a “useful” condition, and a sixth signal representing a “not useful” condition.

The defined outcomes may correspond to the received diagnosis.

The defined outcomes may correspond to the received health care intervention.

The signal may be received when a user performs a single action.

The single action may include selecting a button corresponding to an actual outcome.

The wherein the single action further includes selecting a confirmation button to confirm the actual outcome.

The single action may include at least one of swiping a swipe button, rotating a digital wheel, selecting a point along a continuous scale, and selecting an image among a plurality of images. However, the present general inventive concept is not limited thereto.

The plurality of images may include a first image representing a “better” condition, a second image representing a “worse” condition, a third image representing a “same” condition, a fourth image representing a “resolved” condition, a fifth image representing a “useful” condition, and a sixth image representing a “not useful” condition. In exemplary embodiments, the first image may be a smiley face, the second image may be a frown face, the third image may be a face with a horizontal line for a mouth, and the fourth image may be a smiley face with a heart image.

The method may further include determining an amount of time between the receiving of the unique identifier of the patient and the receiving of the diagnosis of the patient. That is, the method will determine the time between when a patient was entered within the system (i.e., assigned an unique identifier) and when the patient's diagnosis was recorded within the system. This amount of time may be used to calculate efficiency of receiving a diagnosis.

The method may further include determining an amount of time between the receiving of the diagnosis of the patient and the receiving of the health care intervention of the patient. That is, the method will determine the time between when a patient's diagnosis was entered within the system and when the patient's health care intervention was recorded within the system. This amount of time may be used to calculate efficiency of receiving a health care intervention after diagnosis.

The method may further include determining an amount of time between the receiving of the diagnosis of the patient and the receiving of the signal defining the outcome. That is, the method will determine the time between when a patient's diagnosis was entered within the system and when a user (i.e., the patient or the health care provider) recorded the outcome of the particular diagnosis within the system. For instance, the user may determine that the diagnosis was either useful or not useful and the time between this selection and the time when the diagnosis was entered within the system may be used to calculate an efficiency and effectiveness of the diagnosis method.

The method may further include determining an amount of time between the receiving of the health care intervention of the patient and the receiving of the signal defining the outcome. That is, the method will determine the time between when a patient's health care intervention was entered within the system and when a user (i.e., the patient or the health care provider) recorded the outcome of the particular health care intervention within the system. For instance, the user may determine that the health care intervention improved, worsened, had not effect, or resolved the patient's medical condition. This amount of time may be used to calculate an efficiency and effectiveness of the health care intervention.

The method may further include outputting efficiency data representing at least one of an efficiency of the diagnosis and an efficiency of the health care intervention based on at least one of the determined amounts of time.

Although a few exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. A method for correlating health care interventions with a medical condition of a patient, the method comprising:
ascertaining the medical condition of a patient;
running diagnostic tests on the patient;
diagnosing the patient based on medical data;
assigning a health care intervention for the patient;
displaying of information on a user interface, wherein the information includes the patient information, the health care intervention, and a plurality of outcomes; and
in response to an action being performed, documenting an outcome corresponding to the health care intervention.

2. The method of claim 1, wherein the plurality of outcomes include:
(a) Better;
(b) Worse;
(c) Same;
(d) Resolved;
(e) Useful; and
(f) Not-useful.

3. The method of claim 2, wherein said plurality of outcomes are displayed in a format of clickable buttons.

4. The method of claim 1, wherein the action is clicking a button.

5. The method of claim 4, wherein the action further includes a confirmation step.

6. The method of claim 1, comprising the additional steps of:
creating a patient profile; and
designating a unique identifier corresponding to each patient profile.

7. The method of claim 5, wherein the patient profile includes a patient's bibliographic information, a history of the patient's medical records, a patient's current medical conditions, a patient's′ current treatment data, a patient's current medication and/or medication regimens, and a visual display of a plurality of choices to document the result of a health care intervention.

8. A method for obtaining discrete outcome data corresponding to a patient's intervention, the method comprising:
displaying a single user-friendly button on a user interface to indicate a plurality of outcomes of a user's intervention;
determining the patient's outcome from the plurality of outcomes; and
selecting the single user-friendly button corresponding to the determined patient outcome.

9. The method of claim 8, wherein the user interface includes a personal computer, a mobile device, a tablet, and a dedicated electronic device.

10. The method of claim 7, wherein the plurality of outcomes include a first outcome corresponding to the patient's improved condition, a second outcome corresponding to the patient's worsened condition, a third outcome corresponding to the patient's condition remaining the same, and a fourth outcome corresponding to the patient's condition being resolved.

11. The method of claim 9, wherein the single user friendly button includes a slide button movable to a plurality of slide positions corresponding to each outcome, a button corresponding to each outcome, and a wheel movable to a plurality of wheel positions corresponding to each outcome.

12. The method of claim 10, wherein the plurality of slide positions include a first slide position corresponding to the first outcome, a second slide position corresponding to the second outcome, and a third slide position corresponding to the third outcome.

13. The method of claim 10, wherein the plurality of wheel positions include a first wheel position corresponding to the first outcome, a second wheel position corresponding to the second outcome, and a third wheel position corresponding to the third outcome.

14. A method of correlating an outcome to a patient's intervention, the method comprising:
receiving a unique identifier corresponding to each patient;
receiving a diagnosis for each patient;
receiving a health care intervention for each diagnosis;
receiving a signal of a plurality of signals defining an outcome; and
correlating the defined outcome to the unique identifier and at least one of the received diagnosis and the received health care intervention.

15. The method of claim 14, wherein the diagnosis is made according to a medical condition of the patient.

16. The method of claim 14, wherein the health care intervention is determined according to the diagnosis of the patient.

17. The method of claim 14, wherein the plurality of signals include a first signal representing a “better” condition, a second signal representing a “worse” condition, a third signal representing a “same” condition, a fourth signal representing a “resolved” condition, a fifth signal representing a “useful” condition, and a sixth signal representing a “not useful” condition.

18. The method of claim 17, wherein the defined outcomes correspond to the received diagnosis.

19. The method of claim 17, wherein the defined outcomes correspond to the received health care intervention.

20. The method of claim 14, wherein the signal is received when a user performs a single action.

21. The method of claim 20, wherein the single action includes selecting a button corresponding to an actual outcome.

22. The method of claim 21, wherein the single action further includes selecting a confirmation button to confirm the actual outcome.

23. The method of claim 20, wherein the single action includes at least one of swiping a swipe button, rotating a digital wheel, selecting a point along a continuous scale, and selecting an image among a plurality of images.

24. The method of claim 23, wherein the plurality of images include a first image representing a “better” condition, a second image representing a “worse” condition, a third image representing a “same” condition, a fourth image representing a “resolved” condition, a fifth image representing a “useful” condition, and a sixth image representing a “not useful” condition.

25. The method of claim 14, further comprising determining an amount of time between the receiving of the unique identifier of the patient and the receiving of the diagnosis of the patient.

26. The method of claim 14, further comprising determining an amount of time between the receiving of the diagnosis of the patient and the receiving of the health care intervention of the patient.

27. The method of claim 14, further comprising determining an amount of time between the receiving of the diagnosis of the patient and the receiving of the signal defining the outcome.

28. The method of claim 14, further comprising determining an amount of time between the receiving of the health care intervention of the patient and the receiving of the signal defining the outcome.

29. The method of claim 14, further comprising outputting efficiency data representing at least one of an efficiency of the diagnosis and an efficiency of the health care intervention.
